(19) United States
(12) Patent Application Publication
(10) Pub. No.: US 2025/0158198 A1
(43) Pub. Date: May 15, 2025

(54) HANDHELD BATTERY-OPERATED POWER TOOLS, RECHARGEABLE BATTERY PACKS, AND METHODS OF CONTROLLING SUCH POWER TOOLS AND BATTERY PACKS

(71) Applicant: HUSQVARNA AB, Huskvarna (SE)

(72) Inventors: Jan GUSTAVSSON, Jonkoping (SE); Oskar BERGQUIST, Huskvarna (SE); Viktor HENNINGSSON, Jonkoping (SE); David CLAESSON, Tenhult (SE); Karlo MONFARED, Huskvarna (SE)

(21) Appl. No.: 18/837,273

(22) PCT Filed: Jan. 12, 2023
(86) PCT No.: PCT/SE2023/050033

§ 371 Date: Aug. 9, 2024

(30) Foreign Application Priority Data
Feb. 10, 2022 (SE) 2250130-8

(51) Int. Cl. H01M 50/247; H01M 10/44; H01M 50/262; H01R 13/58; H01R 13/66

(52) U.S. Cl. CPC H01M 50/247; H01M 10/443; H01M 50/262; H01R 13/58; H01R 13/6683; H01M 2220/30

(57) ABSTRACT

A handheld battery-operated power tool comprises a work implement, an electric motor configured to operate the work implement, and a connector assembly (32) configured to be releasably coupled to a mating connector counterpart of a removable, rechargeable battery pack (20), for transfer of electric power to the electric motor. The connector assembly (32) comprises a connector temperature sensing arrangement (58) configured to sense a temperature of the connector assembly (32). A rubber cushion (48) enables the connector body (34) to flex in relation to the housing (13a).

### FIELD OF THE INVENTION

The present invention relates to handheld battery-operated power tools, rechargeable battery packs, combinations of and systems comprising such power tools and battery packs, methods of controlling such power tools and battery packs, and computer programs implementing such methods.

### BACKGROUND

Handheld power tools, such as chainsaws, have been known for the last 100 years or so. Due to considerations of weight vs power and operation time, most chainsaws are still powered by internal combustion engines of two-stroke type, but battery powered chainsaws are becoming increasingly popular. However, obtaining high output power without compromising other aspects of the chainsaw, such as cost, weight, battery life before recharging, and usability of the battery with other types of products, still remains a challenge.

### SUMMARY

It is an object of the present invention to solve, or at least mitigate, parts or all of the above mentioned problems. To this end, there is provided a handheld battery-operated power tool comprising a work implement; an electric motor configured to operate the work implement; and a connector assembly configured to be releasably coupled to a mating connector counterpart of a removable, rechargeable battery pack, for transfer of electric power to the electric motor, wherein the connector assembly comprises a connector temperature sensing arrangement configured to sense a temperature of the connector assembly. The connector temperature sensing arrangement makes it possible to, at least temporarily, draw higher current from the battery pack than would otherwise be possible, since the actual conditions of the connector assembly may be monitored. For example, use of Li-ion cells in the battery pack may enable a rather wide operating voltage of, for example, between about 25V and about 42V for a power tool system specified to operate at 36 V, depending on the state of charge of the battery pack. Such a wide voltage range may require increased current during discharge of the battery pack, as the voltage reduces, in order to maintain a certain output power of the power tool. This generates more heat at the connector assembly. Monitoring the temperature of the connector assembly enables increasing the average power of the power tool during the discharge cycle of the battery pack. The connector temperature sensing arrangement may comprise one or more temperature sensors, which may be configured as e.g. thermistor(s) of e.g. negative temperature coefficient type. According to embodiments, the power tool may be configured to draw a maximum power of more than 1.8 KW from the battery pack. For example, the power tool may be an outdoor power tool, for example a leaf blower or a vegetation cutter such as a chainsaw or a clearing saw, or a construction tool such as a power cutter/cut-off machine for cutting e.g. masonry, metal and concrete. The power tool may comprise a battery compartment configured to receive and hold the battery pack.

According to a second aspect, at least parts of the above mentioned problems are solved, or at least mitigated, by a rechargeable battery pack configured to be removably attached to a handheld battery-operated power tool, the rechargeable battery pack comprising a plurality of rechargeable battery cells; and a connector assembly configured to be releasably coupled to a mating connector counterpart of the power tool, for transfer of electric power from the plurality of battery cells to the power tool, wherein the connector assembly comprises a connector temperature sensing arrangement configured to sense a temperature of the connector assembly. The plurality of rechargeable battery cells may be electrically interconnected in groups, for example in serial and/or parallel configuration. The plurality of battery cells may be disposed within a battery housing, and the connector assembly may comprise a set of current transfer connector terminals located so as to be accessible externally of the battery pack. The rechargeable battery cells may be of e.g. Lithium-ion type. According to embodiments, the connector temperature sensing arrangement may be positioned at a distance from the rechargeable battery cells. Thereby, thermal leakage from the rechargeable battery cells to the connector temperature sensing arrangement will be reduced. Preferably, the distance between the connector temperature sensing arrangement and the nearest battery cell exceeds 30 mm. Again, the connector temperature sensing arrangement may comprise one or more temperature sensors, which may be configured as e.g. thermistor(s) of e.g. negative temperature coefficient type. The battery pack may be configured to provide a maximum power of more than 1.8 KW to the power tool.

According to embodiments of the handheld battery-operated power tool and/or battery pack, the connector assembly may comprise a first current transfer connector terminal configured to engage with a respective mating first current transfer connector terminal counterpart of the connector counterpart at a first terminal engagement interface, wherein the connector temperature sensing arrangement comprises a first terminal temperature sensor positioned less than 60 mm from the first terminal engagement interface. The first terminal temperature sensor may be positioned within said distance e.g. along the path of a first electric current transfer line, which may be at least partly defined by a first current transfer cable. According to further embodiments, the first terminal temperature sensor may be positioned less than 40 mm from the first terminal engagement interface.

According to embodiments, the connector assembly may comprise a first current transfer cable, wherein the first terminal temperature sensor is positioned less than 8 mm from a conductor of the first current transfer cable. The first current transfer cable may be coupled to a first current transfer connector terminal as defined above. According to further embodiments, the first terminal temperature sensor may be positioned in direct abutment with the first current transfer cable.

According to embodiments, the connector assembly may comprise a second current transfer connector terminal configured to engage with a respective mating second current transfer connector terminal counterpart of the connector counterpart at a second terminal engagement interface, wherein the connector temperature sensing arrangement comprises a second terminal temperature sensor positioned less than 60 mm from the second terminal engagement interface. According to further embodiments, the second terminal temperature sensor may be positioned less than 40 mm from the second terminal engagement interface. The first current transfer connector terminal may be a positive-voltage current transfer connector terminal, and the second current transfer connector terminal may be a negative-voltage current transfer connector terminal, or vice versa. Depending on e.g. manufacturing tolerances, wear, or other connection circumstances, the first and second terminal engagement interfaces may differ from each other in electrical resistance, and may therefore develop different respective amounts of heat during current transfer. Sensing the temperature of both terminal engagement interfaces enables drawing an even higher average current from the battery pack. Also the second terminal temperature sensor may be positioned within said distance e.g. along the path of a second electric current transfer line, which may be at least partly defined by a second current transfer cable. According to further embodiments, the connector assembly may comprise a second current transfer cable coupled to the second current transfer connector terminal, and the second terminal temperature sensor may be positioned less than 8 mm from a conductor of the second current transfer cable, or in direct abutment with the second current transfer cable.)

According to embodiments, the connector temperature sensing arrangement may comprise a printed circuit board and at least two temperature sensors coupled to the printed circuit board. Such an arrangement facilitates assembly during manufacture of the power tool or battery pack, as the case may be, and ascertains accurate and precise positioning of the temperature sensors.

According to embodiments, the connector assembly may comprise a cable holder provided with one or more apertures, each configured to at least partly enclose and hold respective a current transfer cable, wherein the connector temperature sensing arrangement comprises one or more temperature sensors positioned at said one or more apertures. According to embodiments, a printed circuit board of the connector temperature sensing arrangement may also be carried by said cable holder.

According to embodiments, the handheld battery-operated power tool and/or battery pack may further comprise a rigid main body frame, wherein the connector assembly comprises a rigid connector body and a resilient connector body support, wherein the connector body is attached to the main body frame via the connector body support. Thereby, the connector assembly may automatically align itself to the position of the connector counterpart during connection, regardless of any dirt in the connector or slight positional deviations within manufacturing tolerances. This enables an improved electrical connection between the connector assembly and the connector counterpart, which increases the electric power transfer capability of, and reduces the heat generated in, the electrical connector interface defined by the connector assembly and the mating connector counterpart. According to embodiments, the connector body support may be made of an elastomer, such as natural or synthetic rubber. The connector temperature sensing arrangement may be attached to the rigid main body frame via the resilient connector body support. The rigid main body frame may be defined by, as the case may be, a power tool housing or a battery housing. According to embodiments, the battery housing may be configured to be rigidly connected to the power tool housing. Needless to say, each of the rigid main body frame and the rigid connector body may consist of several respective elements which are interconnected in a rigid manner. The rigid connector body may carry a set of current transfer connector terminals. The current transfer connector terminals may be configured as cantilever finger contacts configured to resiliently flex, during connection, in a direction perpendicular to a connection direction of the connector counterpart. The current transfer connector terminals may be hermaphroditic.

According to embodiments, the connector counterpart may be configured to be coupled to the connector assembly along a connection direction, wherein the resilient connector body support is configured to enable the connector body to resiliently yield in the connection direction. According to embodiments, the resilient connector body support may be configured to enable the connector body to resiliently yield in the connection direction over a maximum flexing range of between 0.5 mm and 4 mm. The resilient connector body support may be configured to enable the connector body to resiliently yield also in a direction perpendicular to the connection direction, or in any direction along a plane perpendicular to the connection direction. The rigid main body frame may comprise a rigid connector sheath enclosing the connector body and extending along the connection direction.

According to embodiments, the resilient connector body support may be configured as a cushion pad sandwiched between the connector body and the main body frame. Thereby, an attractive degree of flexibility may be obtained in a compact space, and at a low cost and complexity. The cushion pad may be made of elastomer, for example thermoplastic elastomer.

According to embodiments, the cushion pad may have a thickness, in the connection direction, of between 2 mm and 10 mm. According to further embodiments, the cushion pad may have a thickness in the connection direction of between 3 mm and 6 mm.

According to embodiments, the cushion pad may be integrally formed with a cable holder. The cable holder may be formed of e.g. non-elastomeric plastic, for example a non-elastomeric thermoplastic. The cable holder and cushion pad may be formed as a two-component injection-moulded element. The connector temperature sensing arrangement may be carried by the cable holder.

According to embodiments, the handheld battery-operated power tool and/or battery pack may further comprise a controller configured to set, based on a sensor signal from the connector temperature sensing arrangement, an upper power limit that can be drawn from the battery pack. According to further embodiments, the controller may be configured to, in response to a determination that the connector temperature exceeds a power limitation threshold temperature, enable the power tool to be operated in a normal-power mode, and in response to a determination that the connector temperature is below a power limitation removal threshold temperature, enable the power tool to be operated in a high-power mode, which high-power mode enables operating the power tool at a higher power than in the normal-power mode. The power tool may be equipped with a user interface, for example an indicator lamp, configured to indicate whether the power tool is in the high-power mode or in the normal-power mode. The power limitation threshold temperature and the power limitation removal threshold temperature may be the same or different. The power limitation threshold temperature and the power limitation removal threshold temperature may be static, or may be dynamically set by the controller. For example, the controller may set the power limitation threshold temperature and the power limitation removal threshold temperature based on a difference between the sensor signal from the connector temperature sensing arrangement and a sensor signal from an ambient temperature sensor separate from the connector temperature sensing arrangement. According to embodiments, the power tool may be configured to draw more than 2.5 KW in the high-power mode, and less than 2.5 KW in the normal-power mode. Exemplary suitable values of the power limitation threshold temperature and the power limitation removal threshold temperature may be, e.g., between 50° C. and 100° C. Alternatively or additionally, the controller may be configured to initiate, based on the sensor signal from the connector temperature sensing arrangement, a connector overheating protection action. The a connector overheating protection action may comprise, e.g., operating a cooling fan configured to cool the connector.

According to a third aspect, at least parts of the above mentioned problems are solved, or at least mitigated, by a handheld battery-operated power tool comprising a main body frame; a work implement carried by the main body frame; an electric motor carried by the main body frame and configured to operate the work implement; and a connector assembly configured to be releasably coupled to a mating connector counterpart of a removable, rechargeable battery pack, for transfer of electric power to the electric motor, wherein the connector assembly is configured to be coupled to the connector counterpart along a connection direction, wherein the connector assembly comprises a rigid connector body and a resilient connector body support configured as a cushion pad sandwiched between the connector body and the main body frame to enable the connector body to resiliently yield in the connection direction.

According to a fourth aspect, at least parts of the above mentioned problems are solved, or at least mitigated, by a rechargeable battery pack configured to be removably attached to a handheld battery-operated power tool, the rechargeable battery pack comprising a rigid main body frame; a plurality of rechargeable battery cells held by the main body frame; and a connector assembly configured to be releasably coupled to a mating connector counterpart of the power tool, for transfer of electric power from the plurality of battery cells to the power tool, wherein the connector assembly comprises a rigid connector body and a resilient connector body support configured as a cushion pad sandwiched between the connector body and the rigid main body frame to enable the connector body to resiliently yield in the connection direction.

According to embodiments of the handheld tool and the battery pack, respectively, the cushion pad may made of elastomer. The cushion pad may have an exemplary thickness of between 2 mm and 10 mm; more preferably between 3 mm and 6 mm, and/or may be configured to enable the connector body to resiliently yield in the connection direction over an exemplary maximum flexing range of between 0.5 mm and 4 mm. The cushion pad may be integrally formed with a cable holder provided with one or more apertures, each configured to at least partly enclose and hold respective a current transfer cable. The cable holder may be non-elastomeric, and may be integrally formed with the cushion pad by e.g. two-component injection moulding. Again, according to embodiments, the rigid main body frame may be defined by, as the case may be, a power tool housing or a battery housing. The battery housing may be configured to be rigidly connected to the power tool housing. Each of the rigid main body frame and the rigid connector body may consist of several respective elements which are interconnected in a rigid manner. The rigid connector body may carry a set of current transfer connector terminals. The current transfer connector terminals may be cantilever finger contacts configured to resiliently flex, during connection, in a direction perpendicular to a connection direction of the connector counterpart. The current transfer connector terminals may be hermaphroditic. The resilient connector body support may be configured to enable the connector body to resiliently yield also in a direction perpendicular to the connection direction, or in any direction along a plane perpendicular to the connection direction. The rigid main body frame may comprise a connector sheath enclosing the connector body and extending along the connection direction.

According to a fifth aspect, at least parts of the above mentioned problems are solved, or at least mitigated, by a combination of a handheld battery-operated power tool in accordance with any of the first and third aspects, and a battery pack in accordance with any of the second and fourth aspects. In such a combination, the connector assembly of the battery pack would define the connector counterpart to be connected to the connector assembly of the power tool, and vice versa. According to an exemplary combination, the connector assembly of the power tool may comprise a connector temperature sensing arrangement as defined hereinabove, and the connector assembly of the battery pack may comprise a cushion pad as defined hereinabove, or vice versa.

According to a sixth aspect, at least parts of the above mentioned problems are solved, or at least mitigated, by a tool system comprising a first handheld battery-operated power tool; a second handheld battery-operated power tool; and a removable, rechargeable battery pack configured to be alternately coupled to the first handheld battery-operated power tool and the second handheld battery-operated power tool, wherein the second handheld battery-operated power tool has a respective upper power limit that can be drawn from the battery pack, the respective upper power limit being independent of a temperature of an electrical coupling interface between the battery pack and the second handheld battery-operated power tool; and the first handheld battery-operated power tool is the handheld battery-operated power tool according to the first aspect defined hereinabove, wherein the respective upper power limit of the first handheld battery-operated power tool may be set to a value which is higher than the respective upper power limit of the second handheld battery-operated power tool. Such a system enables interoperation between high-power tools and legacy low-power power tools and battery packs, while maximizing the power of the high-power tools.

According to a seventh aspect, at least parts of the above mentioned problems are solved, or at least mitigated, by a method of controlling a handheld battery-operated power tool to draw power from a battery pack, the method comprising: sensing a temperature of a connector in an electrical coupling interface between the handheld battery-operated power tool and the battery pack; in response to a determination that the connector temperature exceeds a power limitation threshold temperature, enabling the power tool to be operated in a normal-power mode; and, in response to a determination that the connector temperature is below a power limitation removal threshold temperature, enabling the power tool to be operated in a high-power mode, which high-power mode enables operating the power tool at a higher power than in the normal-power mode. The power limitation threshold temperature and the power limitation removal threshold temperature may be the same or different.

According to an eighth aspect, there is provided data processing equipment comprising at least one processor and memory, configured to carry out the method defined hereinabove.

According to a ninth aspect, there is provided a computer program product comprising instructions which, when the program is executed on a processor, carries out the method defined hereinabove.

According to a tenth aspect, there is provided a computer-readable storage medium (99) having stored thereon said computer program product.

It is noted that embodiments of the invention may be embodied by all possible combinations of features recited in the claims. Further, it will be appreciated that the various embodiments described for the devices are combinable with the methods, and vice versa.

### BRIEF DESCRIPTION OF THE DRAWINGS

The above, as well as additional objects, features and advantages of the present invention, will be better understood through the following illustrative and non-limiting detailed description of preferred embodiments of the present invention, with reference to the appended drawings, where the same reference numerals will be used for similar elements, wherein:

FIG. 1A is a plan view of a handheld battery-powered chainsaw as seen from the side, the chainsaw holding a rechargeable battery;

FIG. 1B is a plan view of the chainsaw of FIG. 1A as seen from above;

FIG. 2A is a perspective view of a power unit body of the chainsaw of FIG. 1A during insertion of the battery;

FIG. 2B is a magnified view of the area indicated by B in FIG. 2A, illustrating a connector assembly of the chainsaw;

FIG. 2C is a magnified view of a portion of FIG. 2B;

FIG. 3 is a plan view of the battery of FIG. 1A;

FIG. 4 illustrates a section of the battery of FIG. 3 in perspective, the section indicated by the line IV-IV in FIG. 3;

FIG. 5A is an exploded view in perspective of the connector assembly of FIG. 2B;

FIG. 5B is an exploded view of the connector assembly of FIG. 2B, as seen from a different perspective;

FIG. 6 is a perspective view of a section of the chainsaw and battery of FIG. 1A, the section indicated by the line VI-VI in FIG. 1A;

FIG. 7A is a perspective view of a set of current transfer connectors of the chainsaw and battery of FIG. 1A prior to connection;

FIG. 7B is a section of the current transfer connectors of FIG. 7A after connecting;

FIG. 8 illustrates a tool system comprising the chainsaw and battery of FIG. 1, and an additional chainsaw;

FIG. 9 is a flowchart illustrating a method of controlling the chainsaw and battery of FIG. 1A; and

FIG. 10 is a perspective view of a data carrier.

All the figures are schematic, not necessarily to scale, and generally only show parts which are necessary in order to elucidate the embodiments, wherein other parts may be omitted.

### DETAILED DESCRIPTION OF THE EXEMPLARY EMBODIMENTS

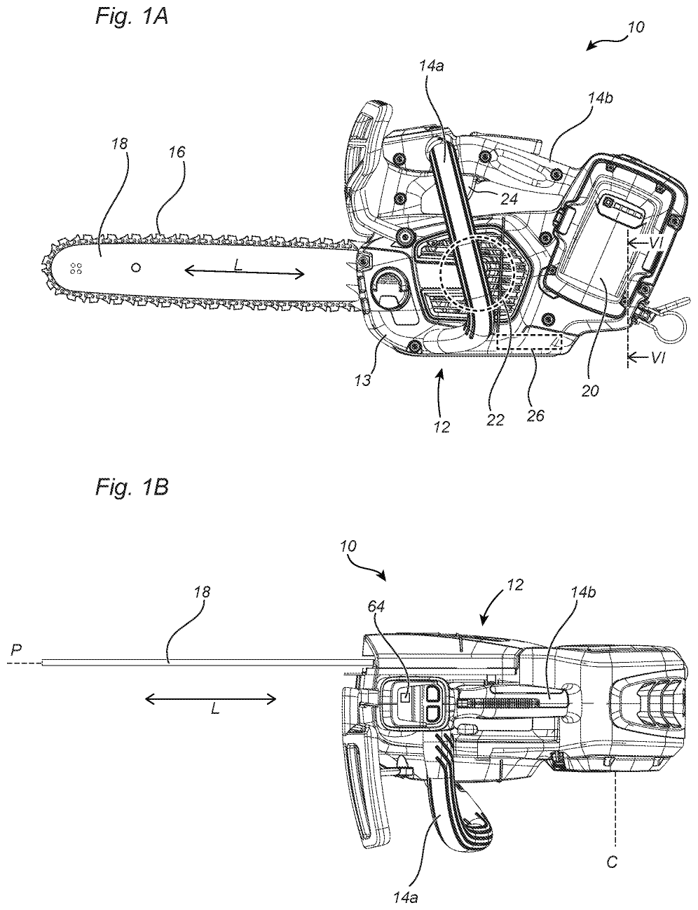

FIG. 1A illustrates a handheld battery-operated power tool embodied as an electric chainsaw 10. The power tool 10 comprises a power unit body 12 provided with a pair of handles 14a, 14b, by means of which an operator (not illustrated) may hold and operate the power tool 10. The pair of handles comprises a front handle 14a, typically for holding with the left hand, and a rear handle 14b, typically for holding with the right hand. The rear handle 14b is positioned on the top of the power unit body 12, i.e. the exemplary chainsaw 10 is of so-called top-handle type; it will however be appreciated that the teachings herein are equally applicable to rear-handle type chainsaws, as well as to other types of handheld battery-operated power tools. The power unit body 12 holds and operates a work assembly, which for the illustrated case is configured as a cutting assembly comprising a saw chain 16, and an elongate guide bar 18 guiding the saw chain 16 in an elongate loop. The cutting assembly extends in a longitudinal direction L from a front end of the power unit body 12. The power tool 10 further comprises a removable, rechargeable battery pack 20, an electric motor 22 (only schematically indicated by a broken-line circle in FIG. 1A), and a finger-operated trigger 24 permitting the operator to control the flow of electric power from the battery pack 20 to the electric motor 22. Thereby, the operator can selectively mobilize the saw chain 16 using the electric motor 22. The power tool 10 further comprises a controller 26 (only schematically indicated by a broken-line rectangle in FIG. 1A) configured to control the electric motor 22 based on input from the trigger 24. The trigger 24 extends downwards from a bottom face of the rear handle 14b, and is movable between a released position (illustrated), in which the which the saw chain 16 is immobilized, and a fully depressed position (not illustrated), responsive to which the electric motor 22 is operated to move the saw chain 16.

FIG. 1B illustrates the power tool 10 from above, and without the saw chain 16. The guide bar extends in a main extension plane P along the longitudinal direction L.

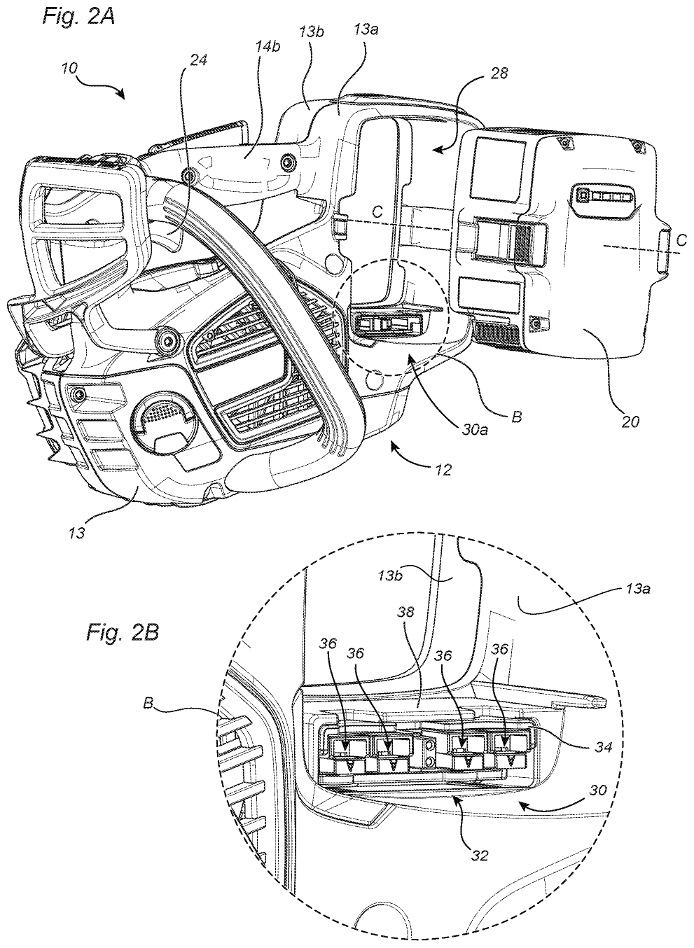

Now with reference to FIG. 2A, the power unit body 12 comprises a battery compartment 28 shaped to receive and enclose the battery pack 20. The battery compartment 28 is provided with an electrical connector 30 configured to be releasably coupled to a mating electrical connector counterpart (not visible in FIG. 2A) of the battery pack 20, for transfer of electric power to the electric motor 22 (FIG. 1A). The battery pack 20 is insertable into battery compartment 28 of the power unit body 12 along an insertion direction C, which in the illustrated example extends perpendicular to the main extension plane P (FIG. 1B) of the guide bar 18 (FIG. 1B). The insertion direction C also defines a connection direction of connecting the electrical connector of the battery pack 20 to the electrical connector 30 of the power tool 10. The power unit body 12 comprises a rigid power tool housing 13, which functions as a rigid main body frame of the power unit body 12, providing structural support to the various component therein. The power tool housing 13 comprises a first housing part 13a and a second housing part 13b, which are rigidly joined with each other.

FIG. 2B illustrates the connector 30 in greater detail. The connector 30 is made up of a connector assembly 32 comprising a rigid connector body 34 holding a set of connector terminals 36, which connector terminals 36 are located so as to be accessible externally of the housing 13 (FIG. 2A) when the battery pack 20 (FIG. 1A) is not connected thereto. The first housing part 13a comprises a rigid connector sheath 38, which encloses the connector body 34 and defines a sleeve extending along the connection direction C (FIG. 2A).

FIG. 2C illustrates the connector assembly 32 in even greater detail. The set of connector terminals 36 comprises a first current transfer connector terminal 40a and a second current transfer connector terminal 40b, each configured to engage with a respective mating current transfer connector terminal counterpart (not illustrated) of the connector counterpart (not illustrated). The first current transfer connector terminal 40a is a positive terminal configured to receive an electric current from the battery pack 20, and the second current transfer terminal 40b is a negative terminal configured to return the electric current to the battery pack 20. A set of control terminals 42 enable exchange of control signals between the power tool 10 and the battery pack 20, for e.g. power control, exchange of battery status information, etc.

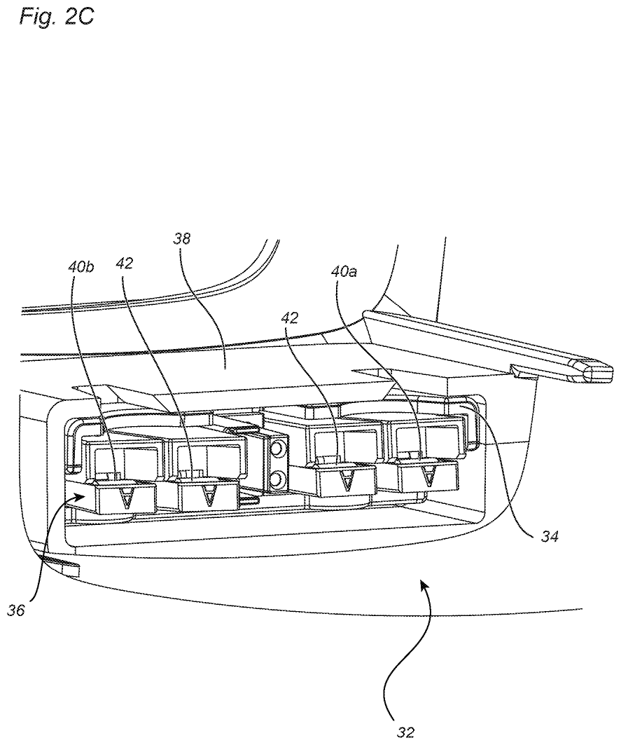

FIG. 3 illustrates the side face of the battery pack 20 which, in FIG. 2A, faces the electric connector 30 of the power tool 10. The battery pack 20 comprises a plurality of rechargeable battery cells (not illustrated) of lithium-ion type disposed within a battery housing 21. The battery pack 20 is further provided with an electrical connector 130 configured to be releasably coupled to a mating electrical connector counterpart of the power tool 10, i.e. to the electric connector 30 (FIG. 2A) of the power tool 10, for transfer of electric power to the electric motor 22 (FIG. 1A) of the power tool 10. Similar to the connector 30 of the power tool, the connector 130 of the battery pack 20 is made up of a connector assembly 132 comprising a respective rigid connector body 134 holding a respective set of connector terminals 136, which are accessible externally of the housing 21 when the battery pack 20 is not connected to the power tool 10 (FIG. 1). A rigid connector sheath 138 is defined by the battery housing 21, and encloses the connector body 134 to define a sleeve extending along the connection direction C (FIG. 2A).

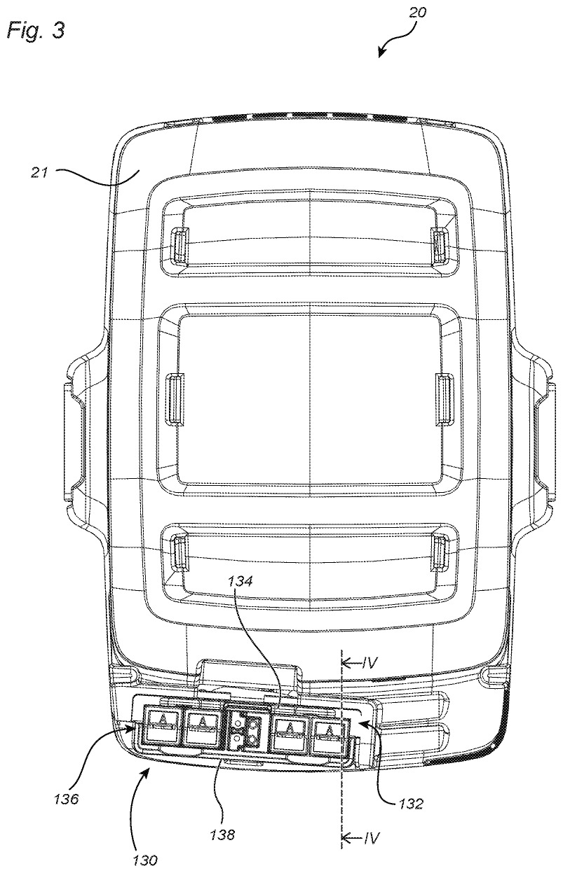

FIG. 4 illustrates a section of the battery pack 20. The set of connector terminals 136 comprises a first current transfer connector terminal 140a and a second current transfer connector terminal 140b, each configured to engage with a respective mating current transfer connector terminal counterpart, i.e. the corresponding first and second current transfer connector terminals 40a, 40b (FIG. 2C) of the connector 30 of the power tool 10. The section also illustrates the battery cells 45 of the battery pack 20, which cells 45 in a non-illustrated manner are electrically interconnected in groups in serial as well as parallel configuration, to provide a combined voltage of about 36 V between the first and second current transfer connector terminals 140a, 140b. Current transfer cables 144a, 144b are connected to respective ones of the first and second current transfer connector terminals 140a, 140b for transfer of electric power from the battery cells 45. Similar to the power tool housing 13 (FIG. 2A), also the battery pack housing 21 comprises a plurality of rigidly interconnected parts 21a, 21b, 21c, one of which, 21a, defines the connector sheath 138.

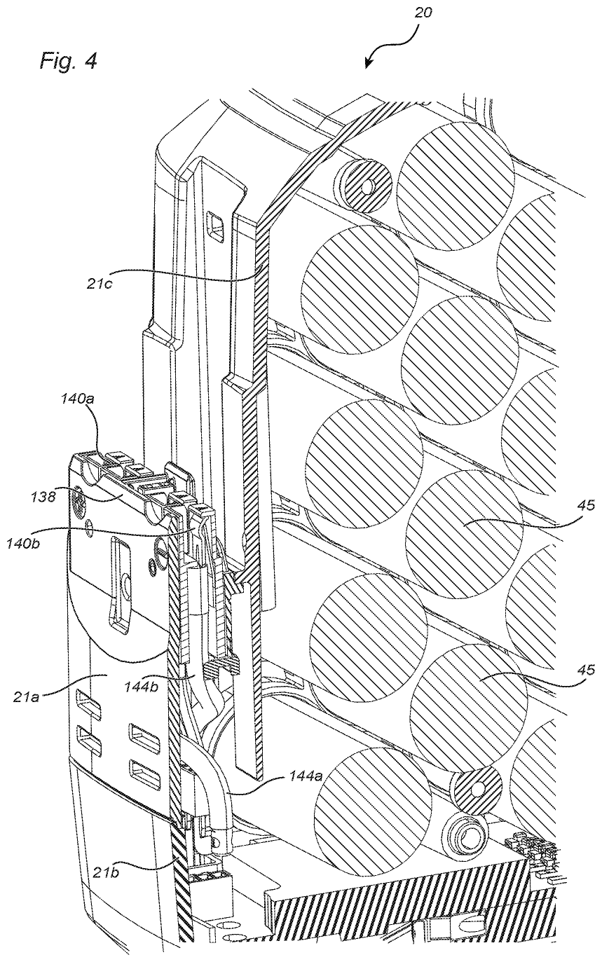

Now returning to the connector assembly 32 of the power tool 10 (FIG. 2A), FIG. 5A illustrates the rigid connector body 34, which holds the current transfer connector terminals 40a, 40b (FIG. 2C; not illustrated in FIG. 5A). The connector body 34 is resiliently connected to the power tool's 10 main body frame, represented by the second housing part 13b, via a resilient connector body support 48 configured as a rubber cushion pad arranged between the connector body 34 and the second housing part 13b. The connector body support 48 and the connector body 34 are both attached to a set of screw anchor pillars 50 integrally formed with the second housing part 13b by means of a set of attachment screws 52, one of which is illustrated. Thanks to the resilient attachment, the connector assembly 32 may automatically align itself to the position of the connector counterpart during connection, within the flexing range permitted by the flexibility of the connector body support 48. In particular, the connector body support enables the rigid connector body 34 to flex in relation to the rigid housing 13 (FIG. 2A) along the connection direction C, as well as in a plane perpendicular to the connection direction C. The cushion pad has a thickness T, in the connection direction, of about 4 mm, and enables the connector body 34 to resiliently yield in the connection direction C over a maximum flexing range of about 1 mm. The cushion pad 48 is integrally formed with a cable holder 54, which is provided with cable holding apertures 56a, 56b accessible from the edge of the cable holder 54. Thereby, current transfer cables 44a, 44b can be pressed into respective apertures 56a, 56b of the cable holder 54 in a cable insertion direction perpendicular to the respective cable's extension direction, to the position illustrated in FIG. 5B.

FIG. 5B illustrates the connector assembly 32 with a first current transfer cable 44a connected to the first current transfer terminal 40a, the first current transfer cable 44a held in a first aperture 56a of the cable holder 54, and a second current transfer cable 44b connected to the second current transfer terminal 40b, the second current transfer cable 44b held in a second aperture 56b of the cable holder 54. The cable holder 54 also carries a connector temperature sensing arrangement 58. The temperature sensing arrangement 58 is configured to sense the temperature of the connector assembly, and comprises a first terminal temperature sensor 60a positioned in the first aperture 56a of the cable holder 54, and a second terminal temperature sensor 60b positioned in the second aperture 56b of the cable holder 54. Thereby, the cable holder 54 holds the terminal temperature sensors 60a, 60b in direct abutment with the respective current transfer cables 44a, 44b. The terminal temperature sensors 60a, 60b are connected to a printed circuit board 62 carried by the cable holder 54. While the printed circuit board 62 is only schematically illustrated in the view of FIG. 5B, it will be appreciated that the printed circuit board 62 may be configured to be attached to the housing 13 (FIG. 2A) by means of e.g. the screws 52, for example by sandwiching the printed circuit board 62 between the connector body 34 and the connector body support 48, or between the connector body support 48 and the second housing part 13b.

The terminal temperature sensors 60a, 60b are connected to the controller 26 (FIG. 1A) in a non-illustrated manner. The controller 26 is configured to set, based on sensor signals from the connector temperature sensing arrangement 58, an upper power limit of the electric power that the power tool 10 (FIG. 1A) can draw from the battery pack 20 (FIG. 1). In response to detecting that the temperature of the connector 30 (FIG. 2A), as represented by the highest of the temperatures of the current transfer cables 44, exceeds a power limitation threshold temperature, for example 60 degrees, the controller 26 limits the power tool 10 to be operated in a normal-power mode of e.g. 2.2 KW. In case the controller 26 determines that the temperature of the connector 30 (FIG. 2A) is below a power limitation removal threshold temperature, for example 50 degrees, the controller 26 enables the power tool 10 to be operated in a high-power mode of e.g. 2.7 KW. An indicator lamp 64 (FIG. 1B), which may be provided with the text “Power boost available”, lights up to inform the power tool operator that the power tool 10 is in the high-power mode. By setting a power limitation threshold temperature which is higher than the power limitation removal threshold temperature, the power tool 10 does not switch excessively between the normal and high-power modes.

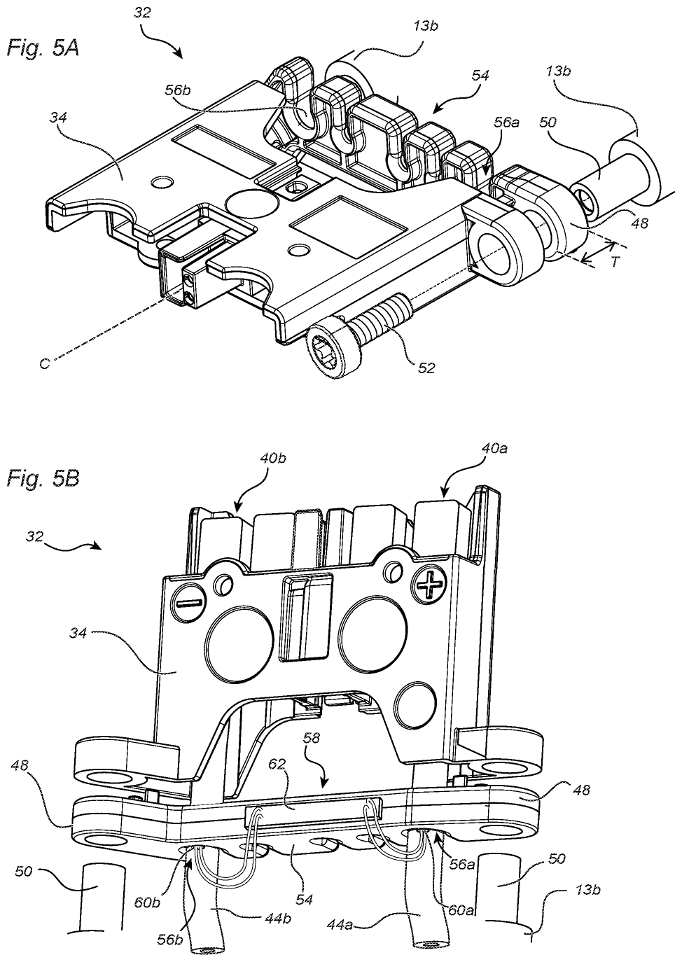

The cross-section of FIG. 6 illustrates the position of the connector assembly 32 within the housing 13 of the power tool 10. The screw 52 attaches the connector body 34, via the resilient connector body support 48, to the screw anchor pillar 50 at the inner face of the second housing part 13b. Of the battery pack 20, only the second and third housing parts 13b, 13c are illustrated in the view of FIG. 6.

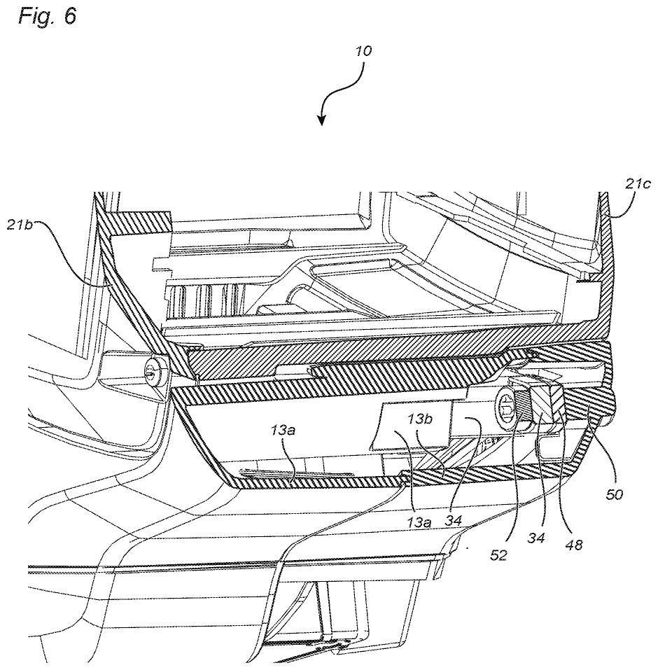

FIG. 7A illustrates the first current transfer connector terminal 40a and the first current transfer cable 44a of the connector assembly 32 (FIG. 2C) of the power tool 10 (FIG. 1A), and the first current transfer connector terminal 140a and the first current transfer cable 144a of the connector assembly 132 (FIG. 3) of the battery pack 20 (FIG. 1A), prior to connecting along the connection direction C. The first current transfer cable 44a of the power tool 10 has a first cable conductor 66, which together with the first current transfer connector terminal 40a defines a first current transfer line, and a first cable insulation sheath 68 enclosing the first cable conductor 66. Each current transfer connector terminal 40a, 140a is configured as cantilever finger contacts configured to resiliently flex, during connection, in a direction perpendicular to the connection direction C, to arrive, when connected, at the position illustrated in FIG. 7B.

In the section of FIG. 7B, which also illustrates the cable holder 54 and the first terminal temperature sensor 60a, the first current transfer connector terminal 40a of the power tool 10 (FIG. 1A) engages with the first current transfer connector terminal 140a of the battery pack 20 (FIG. 1A) at a first terminal engagement interface 70. The first terminal temperature sensor 60a is positioned a distance D1, along the electric current transfer path defined by the first electric current transfer line, of about 15 mm from the first terminal engagement interface 70. The electric current transfer line also operates as a thermal transfer line, such that the temperature of the first terminal engagement interface 70 is quite well represented by the reading of the first terminal temperature sensor 60a in abutment with the first current transfer cable 44a, at a distance D2 of about 2 mm from the conductor 66 of the first current transfer cable 44a. The first terminal temperature sensor 60a is connected to the printed circuit board 62 (FIG. 5B) via leads 69.

It will be appreciated that the second current transfer connector terminal 40b (FIG. 2C) of the power tool 10 (FIG. 1A) engages with the second current transfer connector terminal 140b (FIG. 3) of the battery pack 20 (FIG. 3) at a second terminal engagement interface which may be identical to the first terminal engagement interface 70, and that the second terminal temperature sensor 60b (FIG. 5B) may be positioned accordingly.

Similarly, it will be appreciated that alternatively or additionally, the connector assembly 132 (FIG. 3) of the battery pack 20 may be provided with a similar connector temperature sensing arrangement, which may communicate the connector temperature to the controller 26 of the power tool 10. Alternatively, the connector temperature sensing arrangement may communicate the connector temperature to a controller incorporated within the battery pack, which controller may limit a maximum power available from the battery pack.

Similarly, it will be appreciated that the rigid connector body 134 of the connector assembly 132 of the battery pack 20 may be resiliently connected to the housing 21 of the battery pack 20 via a resilient cushion pad, so as to enable the connector body 134 to flex in relation to the battery pack housing 21.

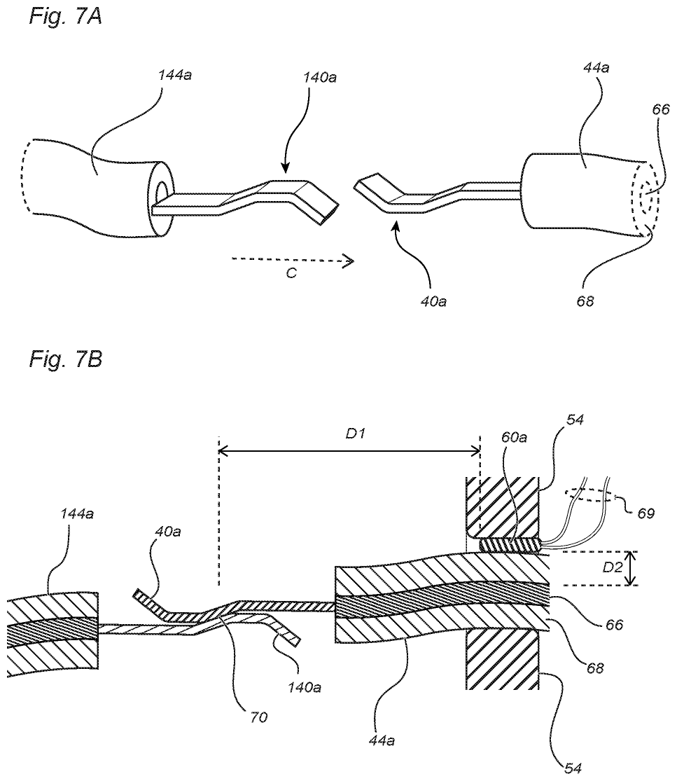

FIG. 8 illustrates a tool system 80 comprising the power tool 10 of FIG. 1A, a second handheld battery-operated power tool 810, and the battery pack 20 of FIG. 3. The battery pack 20 is configured to be alternately coupled to the power tool 10, which represents a first power tool, and to the second power tool 810. The second power tool 810 is substantially identical to the first power tool 10, but differs from the first power tool 10 in that the second power tool 810 is not provided with any terminal temperature sensing arrangement 58 (FIG. 5B). Not having knowledge about the connector temperature, the controller of the second power tool 810 is configured to enable the normal-power mode only, independent of temperature changes in the respective electrical connector 830 of the second power tool 810, whereas the first power tool 10 may be set in the high-power mode, enabling the first power tool 10 to be operated, whenever the respective electrical connector 30 of the first power tool 10 is sufficiently cool, at a higher power than the second power tool 810. Clearly, even though the tool system 80 has been illustrated with reference to two chainsaws 10, 810, this is not necessary. The tool system can comprise, or consist of, other types of handheld battery-operated power tools, such as two leaf blowers, a leaf blower and a hedge trimmer, a chainsaw and a clearing saw, etc.

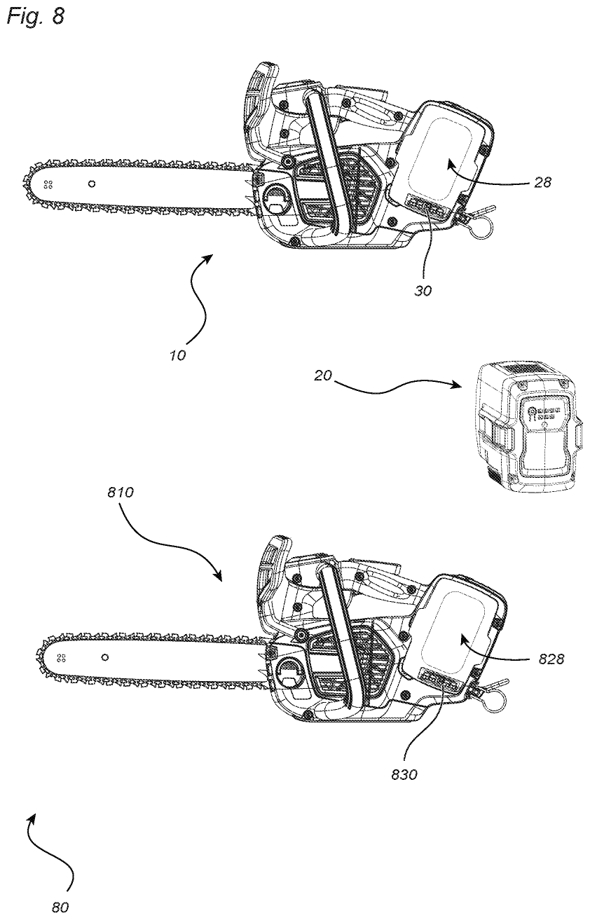

FIG. 9 illustrates a method of controlling the handheld battery-operated power tool 10 of FIG. 1A to draw power from the battery pack 20. The method is implemented in the controller 26, which comprises a processor and memory for the purpose. Alternatively, the method may be implemented in a battery controller within the battery pack 20.

In step 901, the controller 26 senses, using the connector temperature sensing arrangement 58, the temperature of a connector, i.e. connector 30 (FIG. 2A) or 130 (FIG. 3) of the electrical coupling interface between the handheld battery-operated power tool 10 and the battery pack 20.

In step 902, the controller 26 determines whether the connector temperature exceeds the power limitation threshold temperature. If so, the controller sets the power tool 10 or battery pack 20 in a mode enabling the power tool 10 to be operated in a normal-power mode, while preventing operation in the high-power mode.

In step 903, the controller 26 determines whether the connector temperature is below the power limitation removal threshold temperature. If so, the controller 26 sets the battery pack 20 or power tool 10 in a mode enabling the power tool 10 to be operated in the high-power mode, wherein the high-power mode enables operating the power tool 10 at a higher power than in the normal-power mode.

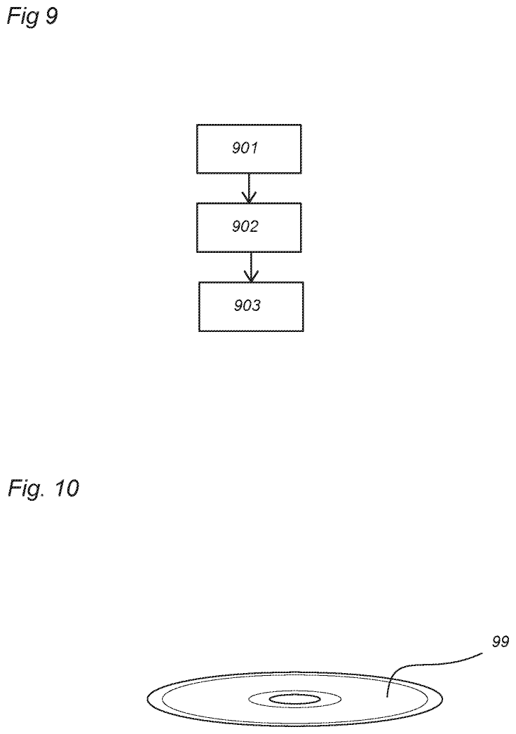

FIG. 10 illustrates a computer-readable storage medium embodied as a CD (compact disc) 99. The CD 99 has stored thereon a computer program product comprising instructions which, when the program is executed on a processor, carries out any of the methods defined hereinabove.

The invention has mainly been described above with reference to a few embodiments. However, as is readily appreciated by a person skilled in the art, other embodiments than the ones disclosed above are equally possible within the scope of the invention, as defined by the appended patent claims.

For example, the invention has been described with reference to a chainsaw of rear-handle type. However, it will be appreciated that the teachings herein are equally applicable to a chainsaw of top-handle type. The temperature sensor(s) of the connector temperature sensing arrangement need not be positioned in direct abutment with current transfer cables; it/they can be positioned at another suitable location within the connector assembly.

In the claims, the word “comprising” does not exclude other elements or steps, and the indefinite article “a” or “an” does not exclude a plurality.

1. A handheld battery-operated power tool comprising
a work implement;
an electric motor configured to operate the work implement; and
a connector assembly configured to be releasably coupled to a mating connector counterpart of a removable, rechargeable battery pack, for transfer of electric power to the electric motor,
wherein the connector assembly comprises a connector temperature sensing arrangement configured to sense a temperature of the connector assembly.

2. A rechargeable battery pack configured to be removably attached to a handheld battery-operated power tool, the rechargeable battery pack comprising
a plurality of rechargeable battery cells; and
a connector assembly configured to be releasably coupled to a mating connector counterpart of the power tool, for transfer of electric power from the plurality of battery cells to the power tool,
wherein the connector assembly comprises a connector temperature sensing arrangement configured to sense a temperature of the connector assembly.

3. The handheld battery-operated power tool according to claim 1, wherein the connector assembly comprises a first current transfer connector terminal configured to engage with a respective mating first current transfer connector terminal counterpart of the connector counterpart at a first terminal engagement interface, wherein the connector temperature sensing arrangement comprises a first terminal temperature sensor positioned less than 50 mm from the first terminal engagement interface.

4. The handheld battery-operated power tool according to claim 1, wherein the connector assembly comprises a first current transfer cable, wherein the first terminal temperature sensor is positioned less than 8 mm from a conductor of the first current transfer cable.

5. The handheld battery-operated power tool according to claim 3, wherein the connector assembly comprises a second current transfer connector terminal configured to engage with a respective mating second current transfer connector terminal counterpart of the connector counterpart at a second terminal engagement interface, wherein the connector temperature sensing arrangement comprises a second terminal temperature sensor positioned less than 50 mm from the second terminal engagement interface.

6. The handheld battery-operated power tool according to claim 1, wherein the connector temperature sensing arrangement comprises a printed circuit board and at least two temperature sensors coupled to the printed circuit board.

7. The handheld battery-operated power tool according to claim 1, wherein the connector assembly comprises a cable holder provided with one or more apertures, each configured to at least partly enclose and hold respective a current transfer cable, wherein the connector temperature sensing arrangement comprises one or more temperature sensors positioned at said one or more apertures.

8. The handheld battery-operated power tool according to claim 1, further comprising a rigid main body frame, wherein the connector assembly comprises a rigid connector body and a resilient connector body support, wherein the connector body is attached to the main body frame via the connector body support.

9. The handheld battery-operated power tool according to claim 8, wherein the connector counterpart is configured to be coupled to the connector assembly along a connection direction, wherein the resilient connector body support is configured to enable the connector body to resiliently yield in the connection direction.

10. The handheld battery-operated power tool according to claim 9, wherein the resilient connector body support is configured as a cushion pad sandwiched between the connector body and the main body frame.

11. The handheld battery-operated power tool according to claim 10, wherein the cushion pad has a thickness, in the connection direction, of between 2 mm and 10 mm.

12. The handheld battery-operated power tool according to claim 10, wherein the cushion pad is integrally formed with a cable holder.

13. The handheld battery-operated power tool according to claim 1, further comprising a controller configured to set, based on a sensor signal from the connector temperature sensing arrangement, an upper power limit that can be drawn from the battery pack.

14. A handheld battery-operated power tool comprising
a main body frame;
a work implement carried by the main body frame;
an electric motor carried by the main body frame and configured to operate the work implement; and
a connector assembly configured to be releasably coupled to a mating connector counterpart of a removable, rechargeable battery pack, for transfer of electric power to the electric motor, wherein the connector assembly is configured to be coupled to the connector counterpart along a connection direction,
wherein the connector assembly comprises a rigid connector body and a resilient connector body support configured as a cushion pad sandwiched between the connector body and the main body frame to enable the connector body to resiliently yield in the connection direction.

15. A rechargeable battery pack configured to be removably attached to a handheld battery-operated power tool, the rechargeable battery pack comprising
a rigid main body frame;
a plurality of rechargeable battery cells held by the main body frame; and
a connector assembly configured to be releasably coupled to a mating connector counterpart of the power tool along a connection direction, for transfer of electric power from the plurality of battery cells to the power tool,
wherein the connector assembly comprises a rigid connector body and a resilient connector body support configured as a cushion pad sandwiched between the connector body and the rigid main body frame to enable the connector body to resiliently yield in the connection direction.

16. (canceled)

17. A tool system comprising
a first handheld battery-operated power tool;
a second handheld battery-operated power tool; and
a removable, rechargeable battery pack configured to be alternately coupled to the first handheld battery-operated power tool and the second handheld battery-operated power tool, wherein
the second handheld battery-operated power tool has a respective upper power limit that can be drawn from the battery pack, the respective upper power limit being independent of a temperature of an electrical coupling interface between the battery pack and the second handheld battery-operated power tool; and
the first handheld battery-operated power tool is the handheld battery-operated power tool according to claim 13, wherein the respective upper power limit of the first handheld battery-operated power tool is adjustable to a value which is higher than the respective upper power limit of the second handheld battery-operated power tool.

18. A method of controlling a handheld battery-operated power tool to draw power from a battery pack, comprising:
sensing a temperature of a connector of an electrical coupling interface between the handheld battery-operated power tool and the battery pack;
in response to a determination that the connector temperature exceeds a power limitation threshold temperature, enabling the power tool to be operated in a normal-power mode; and,
and in response to a determination that the connector temperature is below a power limitation removal threshold temperature, enabling the power tool to be operated in a high-power mode, which high-power mode enables operating the power tool at a higher power than in the normal-power mode.

19. Data processing equipment comprising at least one processor and memory, configured to carry out the method of claim 18.

20. A computer program product comprising instructions which, when the program is executed on a processor, carries out the method according to claim 18.

21. A computer-readable storage medium having stored thereon the computer program product of claim 20.
